(19) United States
(12) Patent Application Publication
(10) Pub. No.: US 2010/0055472 A1
(43) Pub. Date: Mar. 4, 2010

(54) FLUOROPOLYMER LAMINATE

(76) Inventors: David J. Bravet, Shrewsbury, MA (US); Robert L. Febonio, Hudson, NH (US); Maryann C. Kenney, Foxboro, MA (US)

Correspondence Address: Fulbright & Jaworski L. L. P.;ATTN MNIPDOCKET_SAINT GOBAIN CERAMICS AND PLASTICS, 600 Congress Avenue, Suite 2400, Austin, TX, 78701, US

(21) Appl. No.: 12/548,769

(22) Filed: Aug. 27, 2009

Related U.S. Application Data
(60) Provisional application No. 61/092,549, filed on Aug. 28, 2008.

(51) Int. Cl. B32B 27/08; B32B 37/00

(52) U.S. Cl. 428/422; 156/272.2; 428/421

(57) ABSTRACT

The invention describes a fluoropolymer laminate that includes a first substrate that can be a modified fluoropolymer having polar functionality and a second substrate. The substrates are laminated at an elevated temperature suitable for lamination to occur and then are subsequently treated with radiation, such as ultraviolet radiation, gamma radiation and/or electron beam.

### CROSS REFERENCE TO RELATED APPLICATIONS

This application claims benefit under 35 U.S.C. §119(e) to U.S. Ser. No. 61/092,549, entitled “Method of Laminating a Fluoropolymer Layer to a Non-Fluoropolymer Layer”, filed Aug. 28, 2008 (attorney docket number 190375/US (0-5279)) the contents of which are incorporated herein by reference in their entirety.

### FIELD OF THE INVENTION

The invention relates generally to laminates having at least one fluoropolymer layer, and methods for their manufacture that are useful as packaging materials.

### BACKGROUND OF THE INVENTION

Multilayer films or laminates are constructions, which attempt to incorporate the properties of dissimilar materials in order to provide an improved performance versus the materials separately. Such properties include barrier resistance to elements such as water, cut-through resistance, weathering resistance and/or electrical insulation. Up until the present invention, such laminates often result in a mis-balance of properties, are expensive, or difficult to handle or process. In particular applications, such as in a photovoltaic front sheet, good interlayer adhesion is needed. In addition, the inner layers may not be fully durable over the life of the laminate without additional protection.

Sophisticated equipment in the electrical and electronic fields requires that the components of the various pieces of equipment be protected from the effects of moisture and the like. For example, photovoltaic cells and solar panels comprising photovoltaic cells must be protected from the elements, especially moisture, which can negatively impact the function of the cells or the conduction of the electricity generated. In addition, circuit boards used in relatively complicated pieces of equipment such as computers, televisions, radios, telephones, and other electronic devices should be protected from the effects of moisture. In the past, solutions to the problem of moisture utilized metal foils as a vapor or moisture barrier. Metal foils if present in the laminate, however, must be insulated from the electronic component to avoid interfering with performance. Previous laminates using metal foils typically displayed a lower level of dielectric strength than was desirable, while other laminates using a metal foil layer were also susceptible to other environmental conditions.

Thin multi-layer films are useful in many applications, particularly where the properties of one layer of the multi-layer film complement the properties of another layer, providing the multi-layer film with properties or qualities that cannot be obtained in a single layer film. Previous multi-layer films provided only one of the two qualities desirable for multi-layer films for use in electronic devices.

A need therefore remains, in particular, for a multi-layer film that provides a well bonded fluoropolymer front sheet that can protect a photovoltaic device.

### BRIEF SUMMARY OF THE INVENTION

The present invention surprisingly provides laminates, and processes to prepare such laminates, that overcome one or more of the disadvantages known in the art. It has been discovered that it is possible to make and use laminates having characteristics, for example, suitable for packaging materials for electronic devices. These laminates help to protect the components from heat, humidity, chemical, radiation, physical damage and general wear and tear. Such packaging materials help to electrically insulate the active components/circuits of the electronic devices. Additionally, such materials provide protective cushioning to electronic devices, such as photovoltaic devices, provide antisoiling properties, chemical resistance and/or are transparent. Transparency is an important advantage the laminates of the invention can provide as this allows solar energy to penetrate through the front sheet encapsulating the photovoltaic device.

In one aspect, the present invention provides a fluoropolymer laminate that includes a first substrate that can be a modified fluoropolymer having polar functionality and a second substrate. The substrates are laminated at an elevated temperature suitable for lamination to occur and then are subsequently treated with high energy radiation, such as ultraviolet radiation, gamma radiation, or electron beam.

In another aspect, the present invention provides a method to prepare a fluoropolymer laminate comprising the steps:

providing a first substrate, comprising a modified fluoropolymer having polar functionality;

providing a second substrate;

contacting the first and second substrates at an elevated temperature suitable to provide a laminate; and

treating the laminate with radiation, such as, ultraviolet radiation, gamma radiation or electron beam.

In the various embodiments of the laminates, typical modified fluoropolymers include PVDF, VDF copolymers, THV, ECTFE, FEP and ETFE. In one particular aspect, the fluoropolymer is modified by treatment prior to lamination by corona discharge (plasma). In particular, the pretreatment can be in the presence of an organic solvent, such as acetone.

The second substrate can be any material that has capability suitable to interact with the modified fluoropolymer under the conditions described herein. Such materials include, but are not limited to, for example natural or synthetic polymers including polyethylene (including linear low density polyethylene, low density polyethylene, high density polyethylene, etc.), polypropylene, such as atactic polypropylene, nylons (polyamides), EPDM, polyesters, polycarbonates, ethylene-propylene elastomer copolymers, polystyrene (including syndiotactic polystyrene), ethylene-styrene copolymers, terpolymers of ethylene-styrene and other C3-C20 olefins (such as propylene), copolymers of ethylene or propylene with acrylic or methacrylic acids, acrylates, methacrylates, ethylene-propylene copolymers, poly alpha olefin melt adhesives such including, for example, ethyl vinyl acetate (EVA), ethylene butyl acrylate (EBA) ethylene methyl acrylate (EMA); ionomers (acid functionalized polyolefins generally neutralized as a metal salt), acid functionalized polyolefins, polyurethanes including, for example, TPUs, olefin elastomers, thermoplastic silicones, polyvinyl butyral or mixtures thereof.

Suitable ionomers include, but are not limited to, those known under the tradenames of Surlyn® (DuPont) and Iotek® (Exxon Mobil).

Suitable thermoplastic silicones include, but are not limited to those under the tradename Geniomer® (Wacker).

Suitable TPU materials include, but are not limited to those under the tradenames of Elastollan® (BASF), Texin® and Desmopan® (Bayer), Estane® (Lubrizol), Krystalflex®, Krystalgran® Avalon® (Huntsmann).

Suitable polyolefin polymers include but are not limited to ethylene or propylene co-polymers of an C₂₋₂₀ α-olefin, more particularly the α-olefin is selected from the group ethylene, propylene, 1-butene, isobutylene, 1-pentene, 1-heptene, 1-octene, 1-nonene and 1-decene and blends or combinations thereof. Suitable examples include, but are not limited to Tradename examples: Amplify®, Affinity®, Versify®, Engage®, Infuse® (Dow Chemicals), Tafmer® (Mitsui Chemicals), Exact®, Exceed®, Achieve®, Vistamaxx® (Exxon Mobil), Adflex® (Basell), Surpass® (Nova), Notio® (Mitsui).

It should be understood that the laminates of the invention can include from 2 layers to about 12 layers of material. For example, the laminates can repeat layering of a first layer and a second layer, and so forth. Additionally, combinations of various layers are included herein, for example, a first layer, a second layer, a third layer differing from the first or second layers and a fourth layer which differs from the first, second or third layers, etc. This layering, again, can be repeated as needed for the application envisioned.

The present invention also provides methods to prepare the laminates noted throughout the specification.

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the detailed descriptions are to be regarded as illustrative in nature and not restrictive.

### DETAILED DESCRIPTION

Among the classes of polymers, fluoropolymers are unique materials because they exhibit an outstanding range of properties such as high transparency, good dielectric strength, high purity, chemical inertness, low coefficient of friction, high thermal stability, excellent weathering, and UV resistance. Fluoropolymers are frequently used in applications calling for high performance in which oftentimes the combination of the above properties is required. However, due to their low surface energy, fluoropolymers are difficult to wet by most if not all non fluoropolymer materials either liquids or solids.

Subsequently, a common issue encountered with fluoropolymers is the difficult adhesion to non fluoropolymer surfaces. Again, this issue is particularly challenging for fluoropolymer composite laminates in which at least one layer is not a fluoropolymer.

The present invention provides novel laminates and methods to prepare the laminates by using suitable materials in conjunction with a lamination process followed by treatment with ultraviolet (UV) light. In general the laminates of the invention include a first substrate comprising a modified fluoropolymer and a second layer suitable for lamination to the first substrate.

The term “modified fluoropolymer” is intended to include fluoropolymers that are either bulk modified for surface modified, or both. Bulk fluoropolymer modification includes inclusion of polar functionality that is included or grafted into or onto the fluoropolymer backbone. This type of modified fluoropolymer material can be used in combination with an unmodified fluoropolymer layer and a non fluoropolymer layer or as the base fluoropolymer layer. For example, maleic anhydride modified ETFE is suitable to adhere Nylon to an untreated ETFE substrate.

Surface modification of fluoropolymers is another way to provide a modified fluoropolymer useful in the present invention. Generally, hydrophilic functionalities are attached to the fluoropolymer surface, rendering it easier to wet and provides opportunities for chemical bonding. There are several methods to functionalize a fluoropolymer surface including chemical etch, physical-mechanical etch, plasma etch, corona treatment, chemical vapor deposition, or any combination thereof. In an embodiment, the chemical etch includes sodium ammonia or sodium naphthalene. An exemplary physical-mechanical etch can include sandblasting and air abrasion with silica. In another embodiment, plasma etching includes reactive plasmas such as hydrogen, oxygen, acetylene, methane, and mixtures thereof with nitrogen, argon, and helium. Corona treatment can include the reactive hydrocarbon vapors such as ketones, e.g., acetone, alcohols, p-chlorostyrene, acrylonitrile, propylene diamine, anhydrous ammonia, styrene sulfonic acid, carbon tetrachloride, tetraethylene pentamine, cyclohexyl amine, tetra isopropyl titanate, decyl amine, tetrahydrofuran, diethylene triamine, tertiary butyl amine, ethylene diamine, toluene-2,4-diisocyanate, glycidyl methacrylate, triethylene tetramine, hexane, triethyl amine, methyl alcohol, vinyl acetate, methylisopropyl amine, vinyl butyl ether, methyl methacrylate, 2-vinyl pyrrolidone, methylvinylketone, xylene or mixtures thereof.

Some techniques use a combination of steps including one of these methods. For example, surface activation can be accomplished by plasma or corona in the presence of an excited gas species. For example c-treatment refers to a method for modifying the surface by corona treatment in the presence of a solvent gas such as acetone.

Not to be limited by theory, the present novel method has been found to provide strong interlayer adhesion between a modified fluoropolymer and a non fluoropolymer interface (or a second modified fluoropolymer). In one way, a fluoropolymer and a non fluoropolymer shape are each formed separately. Subsequently, the fluoropolymer shape is surface treated by the treatment process described in U.S. Pat. Nos. 3,030,290; 3,255,099; 3,274,089; 3,274,090; 3,274,091; 3,275,540; 3,284,331; 3,291,712; 3,296,011; 3,391,314; 3,397,132; 3,485,734; 3,507,763; 3,676,181; 4,549,921; and 6,726,979, the teachings of which are incorporated herein in their entirety for all purposes. Then, the resultant modified fluoropolymer and non fluoropolymer shapes are contacted together for example by heat lamination to form a composite laminate. Finally, the composite laminate is submitted to a UV radiation with wavelengths in the UVA; UVB and/or UVC range.

In one aspect, the surface of the fluoropolymer substrate is treated with a corona discharge where the electrode area was flooded with acetone, tetrahydrofuran methylethyl ketone, ethyl acetate, isopropyl acetate or propyl acetate vapors.

Corona discharge is produced by capacitatively exchange of a gaseous medium which is present between two spaced electrodes, at least one of which is insulated from the gaseous medium by a dielectric barrier. Corona discharge is somewhat limited in origin to alternating currents because of its capacitative nature. It is a high voltage, low current phenomenon with voltages being typically measured in kilovolts and currents being typically measured in milliamperes. Corona discharges may be maintained over wide ranges of pressure and frequency. Pressures of from 0.2 to 10 atmospheres generally define the limits of corona discharge operation and atmospheric pressures generally are preferred. Frequencies ranging from 20 Hz to 100 MHz can conveniently be used: in particular ranges are from 500 Hz, especially 3000 Hz to 10 MHz

When dielectric barriers are employed to insulate each of two spaced electrodes from the gaseous medium, the corona discharge phenomenon is frequently termed an electrodeless discharge, whereas when a single dielectric barrier is employed to insulate only one of the electrodes from the gaseous medium, the resulting corona discharge is frequently termed a semi-corona discharge. The term “corona discharge” is used throughout this specification to denote both types of corona discharge, i.e. both electrodeless discharge and semi-corona discharge.

In another aspect, the surface of the fluoropolymer substrate is treated with a plasma. The phrase “plasma enhanced chemical vapor deposition” (PECVD) is known in the art and refers to a process that deposits thin films from a gas state (vapor) to a solid state on a substrate. There are some chemical reactions involved in the process, which occur after creation of a plasma of the reacting gases. The plasma is generally created by RF (AC) frequency or DC discharge between two electrodes where in between the substrate is placed and the space is filled with the reacting gases. A plasma is any gas in which a significant percentage of the atoms or molecules are ionized, resulting in reactive ions, electrons, radicals and UV radiation.

The vacuum chamber contains two conducting electrodes which are placed opposite each other in the chamber within 3 inches, preferably within 2 inches, more preferably within 1 inch or less of each other. One electrode is connected to an RF power supply and the other electrode is connected to a ground. Alternatively, a DC ion source may be used for ignition of the plasma. The polymeric substrate is placed in contact with the ground electrode.

The vacuum chamber is further connected to a source of gasified liquid that include, acetone, tetrahydrofuran methylethyl ketone, ethyl acetate, isopropyl acetate or propyl acetate or a mixtures thereof. The connections to the gases are typically through mass flow meters. In one configuration, the RF-driven electrode is a shower head electrode, used for the injection of the process gas. The shower head concept leads to a very good uniformity of gas injection on the whole surface.

After a base chamber pressure is reached, hydrogen can be first introduced, followed by a second gas (or combination of gases) into the chamber in a various ratios. For this first step (pre-treatment), hydrogen only is introduced, with the parameters specified above. There is generally no second gas, but, instead of hydrogen, it is possible to use argon, oxygen, ammonia (NH₃), or helium as the pretreatment gas. Mixtures of one or more of these gases are within the scope of the present invention.

The plasma can be ignited by the RF power supply producing about a 40 KHz to about a 2.45 GHz frequency. Alternatively, a DC ion source may be used to ignite the plasma.

Generally, the substrate is treated with a plasma that is tetrahydrofuran methylethyl ketone, ethyl acetate, isopropyl acetate, propyl acetate or mixtures thereof.

Generally the first substrate layer has a thickness of between about 0.2 mil to about 20 mils, between about 1 mil (0.001 inch) and about 10 mils, more particularly between about 2 mils and about 5 mils and in particular between about 0.5 and about 2 mils.

The second substrate layer can have any thickness. Generally, the second substrate has a thickness of between about 1 mil and 50 mils, more particularly between about 10 mils and about 30 mils and in particular between about 15 and about 25 mils.

The laminates of the invention can be used to protect, in particular, electronic components from moisture, weather, heat, radiation, physical damage and/or insulate the component. Examples of electronic components include, but are not limited to, packaging for crystalline-silicon based thick photovoltaic modules, amorphous silicon, CIGS, or CdTe based thin photovoltaic modules, LEDs, LCDs, printed circuit boards, flexible displays and printed wiring boards.

The methods of the invention to prepare the laminates herein provide several surprising advantages over known materials. First, adhesives are not required with the present invention. Second, transparency is maintained and UV stability is also achieved. Third, since there is no additional adhesive material, one less phase is included in the laminate that can effect transparency.

In the specification and in the claims, the terms “including” and “comprising” are open-ended terms and should be interpreted to mean “including, but not limited to . . . .” These terms encompass the more restrictive terms “consisting essentially of” and “consisting of.”

It must be noted that as used herein and in the appended claims, the singular forms “a”, “an”, and “the” include plural reference unless the context clearly dictates otherwise. As well, the terms “a” (or “an”), “one or more” and “at least one” can be used interchangeably herein. It is also to be noted that the terms “comprising”, “including”, “characterized by” and “having” can be used interchangeably.

Unless defined otherwise, all technical and scientific terms used herein have the same meanings as commonly understood by one of ordinary skill in the art to which this invention belongs. All publications and patents specifically mentioned herein are incorporated by reference in their entirety for all purposes including describing and disclosing the chemicals, instruments, statistical analyses and methodologies which are reported in the publications which might be used in connection with the invention. All references cited in this specification are to be taken as indicative of the level of skill in the art. Nothing herein is to be construed as an admission that the invention is not entitled to antedate such disclosure by virtue of prior invention.

Fluoropolymers:

The phrase “fluoropolymer” is known in the art and is intended to include, for example, polytetrafluoroethylene, copolymers of tetrafluoroethylene and hexafluoropropylene, tetrafluoroethylene-perfluoro(alkyl vinyl ether) copolymers (e.g., tetrafluoroethylene-perfluoro(propyl vinyl ether), FEP (fluorinated ethylene propylene copolymers), polyvinyl fluoride, polyvinylidene difluoride, and copolymers of vinyl fluoride, chlorotrifluoroethylene, and/or vinylidene difluoride (i.e., VDF) with one or more ethylenically unsaturated monomers such as alkenes (e.g., ethylene, propylene, butylene, and 1-octene), chloroalkenes (e.g., vinyl chloride and tetrachloroethylene), chlorofluoroalkenes (e.g., chlorotrifluoroethylene, 3-chloropentafluoropropene, dichlorodifluoroethylene, and 1,1-dichlorofluoroethylene), fluoroalkenes (e.g., trifluoroethylene, tetrafluoroethylene (i.e., TFE), 1-hydropentafluoropropene, 2-hydropentafluoropropene, hexafluoropropylene (i.e. HFP), and vinyl fluoride), perfluoroalkoxyalkyl vinyl ethers (e.g., CF₃OCF₂CF₂CF₂OCF═CF₂); perfluoroalkyl vinyl ethers (e.g., CF₃OCF═CF₂ and CF₃C₂CF₂OCF═CF₂), perfluoro-1,3-dioxoles such as those described in U.S. Pat. No. 4,558,142 (Squire), fluorinated diolefins (e.g., perfluorodiallyl ether or perfluoro-1,3-butadiene), and combinations thereof.

The fluoropolymer can be melt-processable, for example, as in the case of polyvinylidene difluoride; copolymers of vinylidene difluoride; copolymers of tetrafluoroethylene, hexafluoropropylene, and vinylidene difluoride (e.g., those marketed by Dyneon, LLC under the trade designation “THV”); copolymers of tetrafluoroethylene and hexafluoropropylene; and other melt-processable fluoroplastics; or the fluoropolymer may not be melt-processable, for example, as in the case of polytetrafluoroethylene, copolymers of TFE and low levels of fluorinated vinyl ethers), and cured fluoroelastomers.

Useful fluoropolymers include those copolymers having HFP and VDF monomeric units.

Useful fluoropolymers also include copolymers of HFP, TFE, and VDF (i.e., THV). These polymers may have, for example, VDF monomeric units in a range of from at least about 2, 10, or 20 percent by weight up to 30, 40, or even 50 percent by weight, and HFP monomeric units in a range of from at least about 5, 10, or 15 percent by weight up to about 20, 25, or even 30 percent by weight, with the remainder of the weight of the polymer being TFE monomeric units. Examples of commercially available THV polymers include those marketed by Dyneon, LLC under the trade designations “DYNEON THV 2030G FLUOROTHERMOPLASTIC”, “DYNEON THV 220 FLUOROTHERMOPLASTIC”, “DYNEON THV 340C FLUOROTHERMOPLASTIC”, “DYNEON THV 415 FLUOROTHERMOPLASTIC”, “DYNEON THV 500A FLUOROTHERMOPLASTIC”, “DYNEON THV 610G FLUOROTHERMOPLASTIC”, or “DYNEON THV 810G FLUOROTHERMOPLASTIC”.

Other useful fluoropolymers also include copolymers of ethylene, TFE, and HFP. These polymers may have, for example, ethylene monomeric units in a range of from at least about 2, 10, or 20 percent by weight up to 30, 40, or even 50 percent by weight, and HFP monomeric units in a range of from at least about 5, 10, or 15 percent by weight up to about 20, 25, or even 30 percent by weight, with the remainder of the weight of the polymer being TFE monomeric units. Such polymers are marketed, for example, under the trade designation “DYNEON FLUOROTHERMOPLASTIC HTE” (e.g., “DYNEON FLUOROTHERMOPLASTIC HTE X 1510” or “DYNEON FLUOROTHERMOPLASTIC HTE X 1705”) by Dyneon, LLC.

Additional commercially available vinylidene difluoride-containing fluoropolymers include, for example, those fluoropolymers having the trade designations; “KYNAR” (e.g., “KYNAR 740”) as marketed by Atofina, Philadelphia, Pa.; “HYLAR” (e.g., “HYLAR 700”) as marketed by Ausimont USA, Morristown, N.J.; and “FLUOREL” (e.g., “FLUOREL FC-2178”) as marketed by Dyneon, LLC. Copolymers of vinylidene difluoride and hexafluoropropylene are also useful. These include for example KYNARFLEX (e.g. KYNARFLEX 2800 or KYNARFLEX 2550) as marketed by Arkema.

Commercially available vinyl fluoride fluoropolymers include, for example, those homopolymers of vinyl fluoride marketed under the trade designation “TEDLAR” by E.I. du Pont de Nemours & Company, Wilmington, Del.

Useful fluoropolymers also include copolymers of tetrafluoroethylene and propylene (TFE/P). These copolymers may have, for example, TFE monomeric units in a range of from at least about 20, 30 or 40 percent by weight up to about 50, 65, or even 80 percent by weight, with the remainder of the weight of the polymer being propylene monomeric units. Such polymers are commercially available, for example, under the trade designations “AFLAS” (e.g., “AFLAS TFE ELASTOMER FA 100H”, “AFLAS TFE ELASTOMER FA 150C”, “AFLAS TFE ELASTOMER FA 150L”, or “AFLAS TFE ELASTOMER FA 150P”) as marketed by Dyneon, LLC, or “VITON” (e.g., “VITON VTR-7480” or “VITON VTR-7512”) as marketed by E.I. du Pont de Nemours & Company, Wilmington, Del.

Useful fluoropolymers also include copolymers of ethylene and TFE (i.e., “ETFE”). These copolymers may have, for example, TFE monomeric units in a range of from at least about 20, 30 or 40 percent by weight up to about 50, 65, or even 80 percent by weight, with the remainder of the weight of the polymer being propylene monomeric units. Such polymers may be obtained commercially, for example, as marketed under the trade designations “DYNEON FLUOROTHERMOPLASTIC ET 6210J”, “DYNEON FLUOROTHERMOPLASTIC ET 6235”, or “DYNEON FLUOROTHERMOPLASTIC ET 6240J” by Dyneon, LLC.

Additionally, useful fluoropolymers include copolymers of ethylene and chlorotrifluoroethylene (ECTFE). Commercial examples include Halar 350 and Halar 500 resin from Solvay Solexis Corp. These examples are 50:50 copolymers.

Other useful fluoropolymers include substantially homopolymers of chlorotrifluoroethylene (PCTFE) such as Aclar from Honeywell.

Fluoropolymeric substrates may be provided in any form (e.g., film, tape, sheet, web, beads, particles, or as a molded or shaped article) as long as fluoropolymer can be melt processed.

Fluoropolymers are generally selected as outer layers to provide chemical resistance, electrical insulation, weatherability and/or a barrier to moisture.

In one embodiment of this invention the surface of the fluoropolymer is modified by treatment prior to lamination. While not being limited by theory, we believe that treatments which are known to introduce polar functionalities on to the surface such as corona, modified corona or plasma treatments are effective for this invention and provide reactive sites for subsequent activation by UV treatment.

The surface modified fluoropolymer can be obtained from several methods including but not limited to corona treatment of the fluoropolymer in the presence of acetone gas (C-treatment process described in DuPont patent 3030290), or plasma treatment including plasma enhanced chemical vapor deposition.

For C-treatment, the fluoropolymer resin layers are stripped of any release liner and then exposed to a corona discharge in an organic gas atmosphere, wherein the organic gas atmosphere comprises acetone or an alcohol of four carbon atoms or less. Acetone is the preferred organic gas. The organic gas is admixed with an inert gas and the preferred inert gas is nitrogen. The acetone/nitrogen atmosphere causes an increase of adhesion of the fluoropolymer resin layer to the inner layer.

All details concerning the corona discharge treatment procedure are provided in a series of U.S. patents assigned to E. I. du Pont de Nemours and Company, USA, described in expired U.S. Pat. No. 3,676,181, and Saint-Gobain Performance Plastics Corporation U.S. Pat. No. 6,726,979, the teachings of which are incorporated herein in their entirety for all purposes. An example of the proposed technique may be found in U.S. Pat. No. 3,676,181 (Kowalski). The atmosphere for the enclosed treatment equipment is a 20% acetone (by volume) in nitrogen and is continuous. The constantly fed layer, for example, is subjected to between 0.15 and 2.5 Watt hrs per square foot of the film/sheet surface. The fluoropolymer can be treated on both sides of the film/shape to increase the adhesion. The material can then be placed on a non-siliconized release liner for storage. Materials that are C-treated last more than 1 year without significant loss of surface wettability, cementability and adhesion.

Fluoropolymers that contain polar functionalized comonomers may also be used for this invention, and may be effective with or without surface treatment prior to lamination. These include for example maleic anhydride functionalized fluoropolymers such as AH2000 from Asahi or HT2203 from Dupont, or carbonyl functionalized fluoropolymers.

### Ionomers

Useful Ionomers include, for example, SURLYN PV-4000, or SURLYN 1702 (DuPont). For example, Surlyn® is the random copolymer poly(ethylene-co-methacrylic acid) (EMAA). The incorporation of methacrylic acid is typically low (<15 mol. %). Some or all of the methacrylic acid units can be neutralized with a suitable cation, commonly Na⁺ or Zn⁺². Surlyn® is produced through the copolymerization of ethylene and methacrylic acid via a high pressure free radical reaction, similar to that for the production of low density polyethylene. The neutralization of the methacrylic acid units can be done through the addition an appropriate base in solution, or in the melt mixing of base and copolymer. (See for example the figure below.)

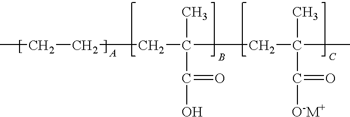

Polyalpha Olefin Melt Adhesives:

Polyalpha olefin melt adhesives are known in the art and include, for example, ethylene alpha olefin copolymers such as ethylene vinyl acetate, ethylene octene, and ethylene propylene.

In particular, suitable PAO hot melt adhesives include ethylene (E)/vinyl acetate (VA) polymers. The ratio of ethylene to vinyl acetate can be controlled and those EVA polymers having a VA content of about 5% to about 40 weight % are particularly useful in this invention.

Laminates of this invention may be formed by a variety of method including thermal lamination, extrusion coating, and extrusion lamination. Thermal lamination refers the process of contacting two films while applying heat and pressure. Generally this is accomplished by heating at least one of the polymers to or near its softening or melting point. Extrusion coating refers to the process of melting a thermoplastic polymer in a extruder and then passing the molten polymer through a die to control layer thickness and depositing it on a moving substrate. As the polymer cools it solidifies and adheres to the substrate. The rate of cooling may be controlled or accelerated with methods such as chill rolls or air knives The coating may be extruded as a single layer, or as multiple layer by simultaneously extruding multiple layers of polymer through a single die in a process referred to as coextrusion. Extrusion lamination is an alternative embodiment of this process in which a molten polymer is extrusion coated on to a first substrate and then a second substrate is immediately applied to the exposed surface of the molten polymer. The molten polymer adheres the two substrates together as it cools. (See for example, Edward M Petrie, “Adhesion in Extrusion and Coextrusion Processes,” SpecialChem4Adhesives website, Jul. 30, 2008).

The present invention provides a method to prepare a fluoropolymer laminate. The steps include providing a first substrate, comprising a modified fluoropolymer having polar functionality; providing a second substrate; contacting the first and second substrates at an elevated temperature suitable to provide a laminate; and treating the laminate with ultraviolet radiation or electron beam.

The process is solvent-free and therefore advantageous from an economic and ecological standpoint.

Typically the elevated temperature range for laminating the first and second substrates together is at least above the melting point or softening point of the second substrate, and more generally about 20° C. to about 50° C. above the melting point or softening point.

Typically, the lamination of the two heated substrates is conducted under pressure or vacuum. This can be accomplished by many known methods in the art, such as vacuum lamination or roll press lamination. Typical pressure applied to the laminate is about 15 psi to about 45 psi, although it can be higher. When a photovoltaic element is already in contact with the laminate, the pressure is controlled so that the photovoltaic element would not be damaged during processing.

In general, the lamination of the two (or more) substrates is accomplished over a period of from about less than a second and several seconds when a roll press process is utilized. Where vacuum lamination is utilized, the process can take about 5 to about 15 minutes for complete lamination of the two or more materials.

Alternatively, lamination could potentially be done in a roll press. So, for a modified fluoropolymer film and a non fluoropolymer contacted in a roll press, low pressure might be from about 1 to about 10 psi, medium pressure could be from about 10 to about 100 psi, high pressure could be from about 100 to about 500 psi, and in extreme cases, even up to about 5000 psi for steel-on-steel nips.

After the two substrates are laminated the laminate is subjected to ionizing radiation, such as ultraviolet light (UV) treatment. The laminate is irradiated with a suitable energy source, such as a 600 W H-bulb, an H⁺ bulb or a D-bulb, or a plasma.

Generally the modified fluoropolymer layer is closest to the UV source when a UV source is utilized.

The laminate can be passed under the UV source multiple times.

The laminate can be treated with the UV source such that a total irradiation time of from about 1 to about 600 seconds occurs, in particular from about 30 to about 420 seconds and particularly from about 90 to about 180 seconds to provide a total dosage of from about 20 to about 4000 J/cm², in particular from about 150 to about 1860 J/cm² and particularly from about 125 to about 250 J/cm².

One method to form this multilayer sheet is by extrusion coating of the second substrate onto a surface modified fluoropolymer.

Adhesion of the substrates is at least about 5 N/inch. Suitable ranges include up to about 80 N/inch, in particular from about 10 to about 70 N/inch and particularly from about 36 to about 60 N/inch as measure by ASTM D-903 (T-peel test method with a travel speed of 2 inch/min).

The following paragraphs enumerated consecutively from 1 through 33 provide for various aspects of the present invention. In one embodiment, in a first paragraph (1), the present invention provides a method to prepare a fluoropolymer laminate comprising the steps: providing a first substrate, comprising a modified fluoropolymer having polar functionality; providing a second substrate; contacting the first and second substrates at an elevated temperature suitable to provide a laminate; and treating the laminate with radiation, such as ultraviolet radiation, gamma radiation, or electron beam

2. The method of claim 1, wherein the polar functionality of the first substrate is part of the polymeric backbone of the fluoropolymer.

3. The method of paragraph 1, wherein the polar functionality of the first substrate is from surface modification of the substrate.

4. The method of paragraph 3, wherein the surface modification is by corona discharge or plasma.

5. The method of paragraph 4, wherein the corona treatment is conducted in the presence of a solvent atmosphere.

6. The method of paragraph 5, wherein the solvent atmosphere is a ketone.

7. The method of any of paragraphs 1 or 3 through 6, wherein the first substrate is ETFE, ECTFE, PCTFE, or FEP.

8. The method of paragraph 1 or 3 through 6, wherein the first substrate is PVDF or PVF.

9. The method of any of paragraphs 1 through 8, wherein the second substrate is a modified fluoropolymer having polar functionality.

10. The method of any of paragraphs 1 through 6, wherein the second substrate is an olefin polymer or copolymer thereof, a functionalized polyolefin, an ionomer, a thermoplastic silicone, polyvinylbutryal, a thermoplastic urethane or mixtures thereof.

11. The method of any of paragraphs 1 through 10, wherein the first and second substrates are contacted in at a temperature at least above the melting point of the second substrate.

12. The method of any of paragraphs 1 through 11, wherein the laminate is treated more than one time with radiation, e.g., ultraviolet light.

13. The method of any of paragraphs 1 through 12, wherein the laminate has an adhesive strength of at least 5 N/inch measured by ASTM D-903.

14. The method of any of paragraphs 1 through 13, further including the step of providing a photovoltaic device encapsulated by the second substrate.

15. A photovoltaic device comprising: a first substrate, comprising a modified fluoropolymer having polar functionality; a second substrate, wherein the first and second substrates provide a laminate that is treated with radiation, such as ultraviolet radiation, gamma radiation, or electron beam; and a photovoltaic component in contact with the second substrate.

16. The photovoltaic device of paragraph 15, wherein the polar functionality of the first substrate is part of the polymeric backbone of the fluoropolymer.

17. The photovoltaic device of paragraph 15, wherein the polar functionality of the first substrate is from surface modification of the substrate.

18. The photovoltaic device of paragraph 17, wherein the surface modification is by corona discharge or plasma.

19. The photovoltaic device of paragraph 18, wherein the corona treatment is conducted in the presence of a solvent atmosphere.

20. The photovoltaic device of paragraph 19, wherein the solvent atmosphere is a ketone.

21. The photovoltaic device of any of paragraphs 15 or 17 through 20, wherein the first substrate is ETFE, ECTFE, PCTFE, or FEP.

22. The photovoltaic device of any of paragraphs 15 or 17 through 20, wherein the first substrate is PVDF or PVF.

23. The photovoltaic device of any of paragraphs 15 through 22, wherein the second substrate is a modified fluoropolymer having polar functionality.

24. The photovoltaic device of any of paragraphs 15 through 20, wherein the second substrate is an olefin polymer or copolymer thereof, a functionalized polyolefin, an ionomer, a thermoplastic silicone, polyvinylbutryal, a thermoplastic urethane or mixtures thereof.

25. The photovoltaic device of any of paragraphs 15 through 24, wherein the first and second substrates are contacted in at a temperature at least above the melting point of the second substrate.

26. The photovoltaic device of any of paragraphs 15 through 25, wherein the laminate is treated more than one time with radiation, such as gamma radiation, ultraviolet light, or electron beam.

27. The photovoltaic device of any of paragraphs 15 through 26, wherein the laminate has an adhesive strength of at least 5 N/inch measured by ASTM D-903.

28. The photovoltaic device of any of paragraphs 15 through 27, further including the step of providing a photovoltaic device encapsulated by the second substrate.

29. The laminate prepared by the method of any of paragraphs 1 through 14.

30. The laminate of paragraph 29, wherein the laminate has an adhesive strength of at least about 10 N/inch measured by ASTM D-903.

31. The laminate of paragraph 29, wherein the laminate has an adhesive strength of at least about 25 N/inch measured by ASTM D-903.

32. The laminate of paragraph 29, wherein the laminate has an adhesive strength of at least about 80 N/inch measured by ASTM D-903.

33. The laminate of paragraph 29, wherein the laminate has an adhesive strength of at least between about 5 N/inch and about 45 N/inch measured by ASTM D-903.

34. A laminate comprising a surface treated fluoropolymer layer, wherein a surface of the fluoropolymer layer contains polar functionality; and a second layer comprising an olefin polymer or copolymer thereof, a functionalized polyolefin, an ionomer, a thermoplastic silicone, polyvinylbutryal, a thermoplastic urethane or mixtures thereof, wherein the modified surface of the fluoropolymer layer is laminated to the second layer with heat and pressure, wherein the outer fluoropolymer surface is subsequently subjected to radiation.

35. The laminate of paragraph 34, wherein the radiation is UV radiation or electron beam.

36. The laminate of either paragraph 34 or 35, wherein the fluoropolymer is ETFE, ECTFE, PCTFE, PVDF, PVF, or FEP.

The laminate of any of paragraphs 34 through 36, wherein the laminate has an adhesive strength of at least between about 5 N/inch and about 80 N/inch measured by ASTM D-903, e.g., at least about 10, 25, 40 N/inch and all values and ranges there between.

The invention will be further described with reference to the following non-limiting Examples. It will be apparent to those skilled in the art that many changes can be made in the embodiments described without departing from the scope of the present invention. Thus the scope of the present invention should not be limited to the embodiments described in this application, but only by embodiments described by the language of the claims and the equivalents of those embodiments. Unless otherwise indicated, all percentages are by weight.

### EXAMPLES

### Example 1

An unmodified ETFE resin from Daikin was extruded into a 2 mils film and surface treated by corona in presence of acetone vapors. The film is surface treated by corona in the presence of acetone vapor with nitrogen blanketing. The film is passed beneath the corona electrodes at a distance of about 1 mm at a speed of 100 feet per minute, using a power source of 7.8 kW to deliver a treatment strength or watt density of 12-16 kW/ft²/min. An ionomer resin supplied by DuPont grade PV4000 was dried and pressed out into a 7 mils film using a heated press set at 350 F under 15 tons for 5 minutes. Then, the ETFE and ionomer films were heat laminated at 350 F with a ChemInstruments HL-100 hot roll laminator with a nip pressure dial setting of 40 psi and a speed of 2.6 fpm. The upper roll was anodized teflon coated aluminum. The lower roll was aluminum covered with 80 durometer silicone rubber. Finally, the laminate was irradiated by UV wavelength delivered by a H-Bulb using 600 W/inch. Laminates were placed on a belt advancing at a rate of 12 feet/min with the fluoropolymer layer facing the UV source. The UV source irradiated the sample in between a 1 inch wide gap; therefore the irradiation time was about 0.4 s for each pass. A total of five passes was used to treat the laminate, which made the total irradiation time of about 2 s and a dose of 194 J/cm2. The adhesion was measured by a T-peel test method (ASTM D-903) using a crosshead speed of 2 inches per minutes. The results are summarized in Table 1 below:

TABLE 1
Table: peel force in N using 1 inch strip by T peel test.

| | UV treatment at 194 J/cm² | | |
|---|---|---|---|
| | | c-treated | Without UV |
| | | ETFE/ | treatment |
| | ETFE no treatment/ | Surlyn | c-treated ETFE/ |
| Laminate | Surlyn PV4000 | PV4000 | Surlyn PV4000 |
| Sample size | 3 | 3 | 3 |
| Yield load | 0.2 +/− 0.2 | 58.6 +/− 1.8* | 0.1 +/− 0.05 |
| (N) | | | |

*Film broke.

Therefore, it was determined that there was a synergistic effect on the fluoropolymer/non fluoropolymer interlayer adhesion when using a combination of c-treatment/heat lamination/UV irradiation.

### Example 2

An unmodified ETFE resin from Daikin was extruded into a 2 mils film and surface treated by corona in presence of acetone vapors. The film is surface treated by corona in the presence of acetone vapor with nitrogen blanketing. The film is passed beneath the corona electrodes at a distance of about 1 mm at a speed of 100 feet per minute, using a power source of 7.8 kW to deliver a treatment strength or watt density of 12-16 kW/ft²/min. A polyolefin resin supplied by Mitsui grade Notio PN3560 (a polyolefin elastomer) was pressed out into a 7 mils film using a heated press set at 350 F under 15 tons for 5 minutes. Then, the ETFE and polyolefin films were heat laminated at 350 F with a ChemInstruments HL-100 hot roll laminator with a nip pressure dial setting of 40 psi and a speed of 2.6 fpm. The upper roll was anodized teflon coated aluminum. The lower roll was aluminum covered with 80 durometer silicone rubber Finally, the laminate was irradiated by UV wavelength with using 600 W H-Bulb. Laminates were placed on a belt advancing at a rate of 12 feet/min with the fluoropolymer layer facing the ceiling. The UV source irradiated the sample in between a 1 inch wide gap; therefore the irradiation time was about 0.4 s for each pass. A total of five passes was used to treat the laminate, which makes the total irradiation time of about 2 s and a dose of 194 J/cm2. The adhesion was measured by a T-peel test method using a crosshead speed of 2 inches per minutes. The results are summarized in Table 2 below:

TABLE
peel force in N using 1 inch strip by T peel test.

| | UV treatment at 194 J/cm² | | Without UV |
|---|---|---|---|
| | ETFE no | | treatment |
| | treatment/Notio | c-treated ETFE/ | c-treated ETFE/ |
| Laminate | PN3560 | Notio PN3560 | Notio PN3560 |
| Sample | 3 | 3 | 3 |
| size | | | |
| Yield load | 0.3 +/− 0.5 | 48.6 +/− 13.2* | 0.1 +/− 0.05 |
| (N) | | | |

*film broke.

Therefore, it was determined that there was a synergistic effect on the fluoropolymer/non fluoropolymer interlayer adhesion when using a combination of c-treatment/heat lamination/UV irradiation.

Although the present invention has been described with reference to preferred embodiments, persons skilled in the art will recognize that changes may be made in form and detail without departing from the spirit and scope of the invention. All references cited throughout the specification, including those in the background, are incorporated herein in their entirety. Those skilled in the art will recognize, or be able to ascertain, using no more than routine experimentation, many equivalents to specific embodiments of the invention described specifically herein. Such equivalents are intended to be encompassed in the scope of the following claims.

What is claimed is:

1. A method to prepare a fluoropolymer laminate comprising the steps:
providing a first substrate, comprising a modified fluoropolymer having polar functionality;
providing a second substrate;
contacting the first and second substrates at an elevated temperature suitable to provide a laminate;
treating the laminate with radiation or electron beam.

2. The method of claim 1, wherein the polar functionality of the first substrate is part of the polymeric backbone of the fluoropolymer.

3. The method of claim 1, wherein the polar functionality of the first substrate is from surface modification of the substrate.

4. The method of claim 3, wherein the surface modification is by corona discharge or plasma.

5. The method of claim 4, wherein the corona treatment is conducted in the presence of a solvent atmosphere.

6. The method of claim 1, wherein the first substrate is ETFE, ECTFE, PCTFE, PVDF, PVF, or FEP.

7. The method of claim 1, wherein the second substrate is a modified fluoropolymer having polar functionality.

8. The method of claim 1, wherein the second substrate is an olefin polymer or copolymer thereof, a functionalized polyolefin, an ionomer, a thermoplastic silicone, polyvinylbutryal, a thermoplastic urethane or mixtures thereof.

9. The method of claim 1, wherein the laminate has an adhesive strength of at least 5 N/inch measured by ASTM D-903.

10. The method of claim 1, further including the step of providing a photovoltaic device encapsulated by the second substrate.

11. A photovoltaic device comprising:
a first substrate, comprising a modified fluoropolymer having polar functionality;
a second substrate, wherein the first and second substrates provide a laminate that is treated with radiation or electron beam; and
a photovoltaic component in contact with the second substrate.

12. The photovoltaic device of claim 11, wherein the polar functionality of the first substrate is part of the polymeric backbone of the fluoropolymer.

13. The photovoltaic device of claim 12, wherein the polar functionality of the first substrate is from surface modification of the substrate.

14. The photovoltaic device of claim 13, wherein the surface modification is by corona discharge or plasma.

15. The photovoltaic device of claim 14, wherein the corona treatment is conducted in the presence of a solvent atmosphere.

16. The photovoltaic device of claim 11, wherein the first substrate is ETFE, ECTFE, PCTFE, PVDF, PVF, or FEP.

17. The photovoltaic device of claim 11, wherein the second substrate is a modified fluoropolymer having polar functionality.

18. The photovoltaic device of claim 11, wherein the second substrate is an olefin polymer or copolymer thereof, a functionalized polyolefin, an ionomer, a thermoplastic silicone, polyvinylbutryal, a thermoplastic urethane or mixtures thereof.

19. The photovoltaic device of any of claim 11, wherein the laminate has an adhesive strength of at least 5 N/inch measured by ASTM D-903.

20. The photovoltaic device of any of claim 11, further including the step of providing a photovoltaic device encapsulated by the second substrate.

21. A laminate comprising:
a surface treated fluoropolymer layer, wherein a surface of the fluoropolymer layer contains polar functionality; and
a second layer comprising an olefin polymer or copolymer thereof, a functionalized polyolefin, an ionomer, a thermoplastic silicone, polyvinylbutryal, a thermoplastic urethane or mixtures thereof, wherein the modified surface of the fluoropolymer layer is laminated to the second layer with heat and pressure, wherein the outer fluoropolymer surface is subsequently subjected to radiation.

22. The laminate of claim 21, wherein the radiation is UV radiation or electron beam.

23. The laminate of claim 21, wherein the fluoropolymer is ETFE, ECTFE, PCTFE, PVDF, PVF, or FEP.
